(19) United States
(12) Patent Application Publication
(10) Pub. No.: US 2014/0138315 A1
(43) Pub. Date: May 22, 2014

(54) METHOD OF MAKING A WATER-STERILIZING POLYMERIC MEMBRANE

(71) Applicant: KING FAHD UNIVERSITY OF PETROLEUM AND MINERALS, Dhahran (SA)

(72) Inventors: RAFIL A. BASHEER, ROCHESTER HILLS, MI (US); NEDAL Y. ABU-THABIT, DHAHRAN (SA)

(73) Assignee: King Fahd University of Petroleum and Minerals, Dhahran (SA)

(21) Appl. No.: 13/684,067

(22) Filed: Nov. 21, 2012

(51) Int. Cl. B01D 67/00; C02F 1/46; B01D 61/42

(52) U.S. Cl. CPC B01D 67/0079; B01D 61/425; C02F 1/46; B82Y 30/00
USPC 210/650; 210/500.25; 427/244; 977/773

(57) ABSTRACT

A water-sterilizing polymeric membrane is made from cotton fibers, conductive polyaniline and silver nanostructures. In a first, two-step method of making the membrane, cotton is coated with a conductive polyaniline polymer, and then silver nano structures are incorporated with the polyaniline-coated cotton by conformal or dip coating. The silver nanostructures may be in the form of silver nanoparticles, silver nanowires, silver flakes, combinations thereof, or the like. In a second, one-step approach, silver nanostructures are generated or synthesized in situ during the polymerization of aniline on the cotton fibers. In use, the membrane is used for a filter electrode by passing electrical current therethrough. Then, water to be sterilized is passed through the electrified matrix membrane, producing potable drinking water. The polyaniline, silver and electrical current all contribute to antimicrobial activity in the matrix membrane.

### BACKGROUND OF THE INVENTION

1. Field of the Invention

The present invention relates generally to the membrane electrodes and to methods for sterilization of water, and particularly to a method of making a water-sterilizing polymeric membrane that can be used as a filter electrode for the sterilization of water through application of an electric field.

2. Description of the Related Art

The lack of potable water is a major problem in many areas of the world. A wide variety of sterilization and decontamination techniques exist for producing potable water. However, most are either difficult and/or costly to implement. The use of silver membrane filters for sterilization is of interest, primarily due to its portability, but the most effective form of silver for such purposes is nanostructures embedded in a matrix membrane. Most nano-production methods are difficult and costly to implement.

Additionally, silver alone is not optimally effective. Thus, the combination of silver nano-structures with other antimicrobial materials and techniques is of further interest. However, given that the nano-structure basis of the material is already difficult to manufacture, adding further materials and techniques compounds the difficulty in providing a cost-effective and efficient matrix membrane filter.

Thus, a method of making a water-sterilizing polymeric membrane solving the aforementioned problems is desired.

### SUMMARY OF THE INVENTION

The method of making a water-sterilizing polymeric membrane relates generally to the manufacture of a polymeric matrix membrane for water sterilization, and to its use for the sterilization of water. The matrix membrane is made from cotton fiber coated with acid-doped conducting polyaniline and silver nanostructures. The silver nanostructures may be in the form of silver nanoparticles, silver nanowires, silver flakes, combinations thereof, and the like. The silver nanostructures may be prepared separately and then added to the polyaniline coated cotton fibers, or they may be synthesized in situ during the formation of the polyaniline (polymerization of aniline) coating on the cotton fibers. The latter process is a cost effective and relatively easy method for the preparation of the matrix membrane.

In use, the matrix membrane is used as a water filtration electrode by passing electrical current therethrough. Then, water to be sterilized is passed through the electrified matrix membrane, producing potable drinking water. The polyaniline, silver and electrical current all contribute to antimicrobial activity in the matrix membrane.

These and other features of the present invention will become readily apparent upon further review of the following specification and drawings.

### BRIEF DESCRIPTION OF THE DRAWINGS

FIG. 1 is a chemical equation for the synthesis of a polyaniline/silver composite by a redox reaction between aniline and silver nitrate.

FIG. 2 is a chemical equation for the synthesis of a polyaniline/silver composite by a redox reaction between aniline, silver nitrate, and ammonium peroxydisulfate.

FIG. 3 is a chemical equation for the synthesis of a polyaniline/silver composite by a redox reaction between an oxidized form of polyaniline and silver nitrate.

FIG. 4 is a schematic diagram of a water filtration device using a water-sterilizing polymeric membrane according to the present invention.

Similar reference characters denote corresponding features consistently throughout the attached drawings.

### DETAILED DESCRIPTION OF THE PREFERRED EMBODIMENTS

The method of making a water-sterilizing polymeric membrane begins by first coating cotton fiber with polyaniline doped with an acid, forming a first composite material. The first composite material is then coated with silver nano structures to form a second composite material. The second composite material, which is a composite of cotton fiber, polyaniline and silver, is then formed into a matrix membrane. The silver nanostructures may be in the form of silver nanoparticles, silver nanowires, silver flakes, combinations thereof, and the like. The coating of the first composite material with the silver nanostructures is performed with dip coating, conformal coating or any other suitable type of coating method. The polyaniline is doped with any suitable acid, such as hydrochloric acid, nitric acid, formic acid, phosphoric acid, sulfuric acid, acetic acid, methanesulfonic acid, trifluromethanesulfonic acid, p-toluenesulfonic acid, naphthalene sulfonic acid, dinonylnaphthalenesulfonic acid, camphorsulfonic acid, polystyrenesulfonic acid, dodecylbenzenesulfonic acid, or combinations thereof.

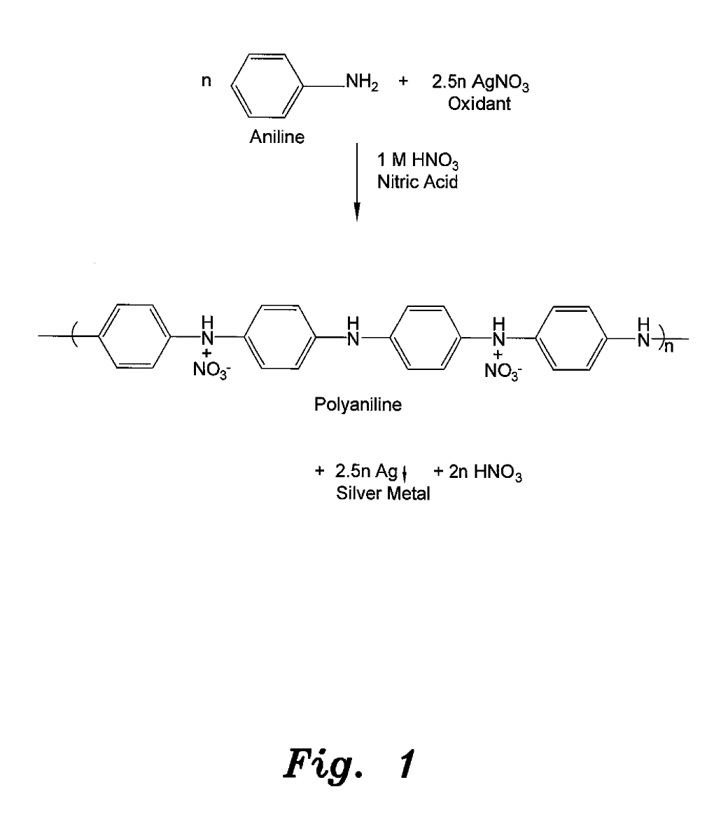

As illustrated in the reaction of FIG. 1, silver nitrate may be used as an oxidizing agent for aniline monomer to form the polyaniline. This reaction preferably takes place in an acidic medium, such as nitric acid or formic acid. The molar concentration of the silver nitrate is between about 0.1 M and 3.0 M. The aniline monomer has a concentration between about 0.1 M and 2.0 M. The ratio of silver nitrate to the aniline monomer is preferably between 0.1 and 8.0. The acidic medium has a concentration of between 0.1 M and 5.0 M, with about 1.0 M nitric acid being used in the preferred embodiment.

The reaction is preferably carried out at room temperature for a period of between one hour and sixty days. In experiments, aniline and silver nitrate solutions were prepared in 1 M nitric acid solution. The reactions were carried out in a 25 ml vial. In one reaction, 7.5 ml of 0.8 M aniline solution and 3 ml of 2.0 M silver nitrate solution were added to the vial and mixed by shaking. Then, a 150 mg cotton sample was placed inside the vial and the reaction was kept at room temperature without shaking. The progress of the reaction was monitored by both color and resistance changes of the cotton fibers sampled at different reaction intervals. After 21 days, the reaction was stopped and the resultant cotton/polyaniline/silver composite was removed from the reaction solution and washed several times with de-ionized water. The composite was then dried in air for 24 hours. The resistance of the cotton/polyaniline/silver composite was 30 Ω/sq.

Additionally, an auxiliary reducing agent (dimethyl formamide (DMF), formic acid, citric acid, ascorbic acid, formaldehyde, hydrogen peroxide, sucrose, and combinations thereof) may be added to increase the rate of the reaction. The auxiliary reducing agent preferably has a concentration of between 0.0001 M and 5.0 M. In experiments with the use of a reducing agent, aniline and silver nitrate solutions were prepared in 1 M nitric acid solution. The reactions were carried out in a 25 ml vial. In one reaction, 8 ml of 0.8 M aniline solution, 8 ml of 2.0 M silver nitrate solution and 4 ml DMF (as the auxiliary reducing agent) were added to the vial and mixed by shaking. Then, a 250 mg cotton sample was placed inside the vial, and the reaction was kept at room temperature without shaking. The progress of the reaction was monitored by both color and resistance changes of the cotton fibers sampled at different reaction intervals. After 12 days, the cotton/polyaniline/silver composite was removed from the reaction solution and washed several times with de-ionized water. The composite was then dried in air for 24 hours. The resistance of the cotton/polyaniline/silver composite was 2 Ω/sq.

The polyaniline doped with the acid, such as nitric acid, may be de-doped using any suitable base, such as ammonium hydroxide, and then re-doped with inorganic, organic or polymeric acids, such as hydrochloric acid, nitric acid, formic acid, phosphoric acid, sulfuric acid, acetic acid, methanesulfonic acid, trifluromethanesulfonic acid, p-toluenesulfonic acid, naphthalene sulfonic acid, dinonylnaphthalenesulfonic acid, camphorsulfonic acid, polystyrenesulfonic acid, dodecylbenzenesulfonic acid, and combinations thereof.

When using DMF as the reducing agent, the resultant composite material is found to consist of various silver nanostructures, including nanoribbons, nanowires, hexagonal flakes and triangular particles, and with polyaniline brushes that form on both the cotton fibers and on the silver nanostructures with coating thicknesses of between 50 nm and 200 nm. It should be understood that other types of fiber material, rather than only cotton, may be used, such as wool, glass wool, ceramic, inorganic or synthetic fibers, combinations thereof or combinations thereof with cotton fiber.

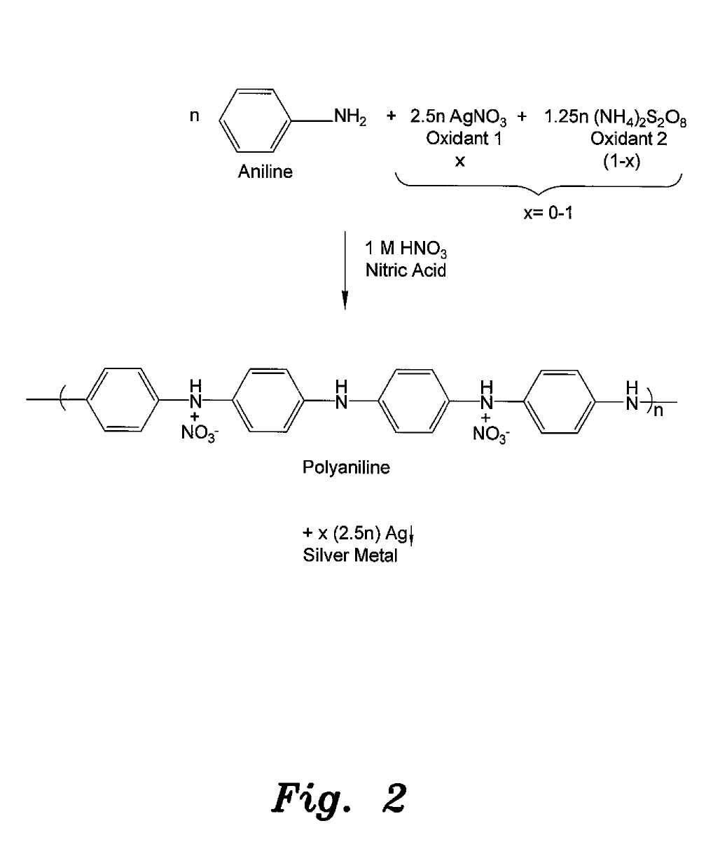

As shown in the reaction of FIG. 2, in an alternative method of manufacture, a mixed oxidants approach may be utilized. In addition to the use of silver nitrate as an oxidizing agent, as described above, a secondary oxidizing agent may be used in the reaction with the aniline monomer. In FIG. 2, ammonium peroxydisulfate is used as the secondary oxidizing agent, although it should be understood that any suitable type of oxidizing agent, such as ferric chloride, benzoic acid peroxide or hydrogen peroxide, may be mixed with the silver nitrate,. In the method of FIG. 2, the reaction is carried out at a temperature between about −20° C. and 30° C. for a time between thirty minutes and one week.

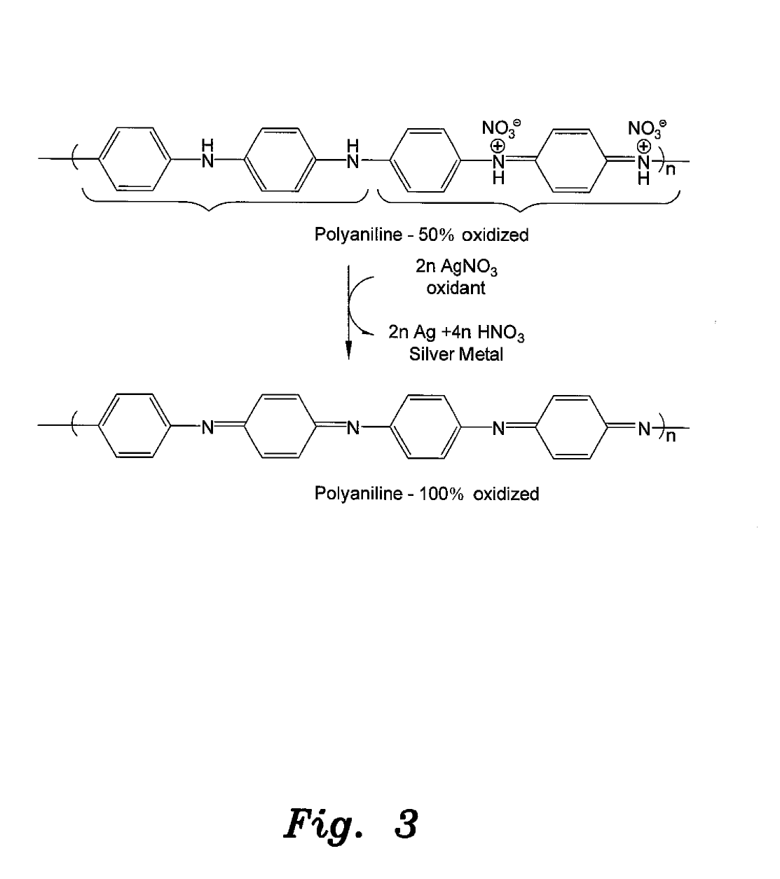

In the further alternative method of making the composite, illustrated in FIG. 3, polyaniline is on the cotton as a reducing agent for the silver nitrate. The silver nitrate has a concentration ranging between about 0.1 M and 1.0 M, and is prepared in either de-ionized water or in 1 M nitric acid. The reaction takes place in a range between about one minute to ten days. The silver forms as nanoparticles with dimensions of between 50 nm and 500 nm, and also as microparticles with dimensions ranging between 1 micron and 50 microns.

In experiments utilizing the above alternative method, 0.40 g of cotton fibers were soaked for two hours in a 0° C. cooled solution of 1.05 g aniline dissolved in 40 ml of 1 M HCl in a 100 ml flask. Another solution of 2.6 g ammonium peroxydisulfate dissolved in 20 ml of 1 M HCl was prepared and cooled to 0° C. The oxidizing agent solution was added directly to the aniline solution with strong stirring, and the reaction temperature was maintained at 0° C. for four hours. Then, the reaction was left overnight at room temperature. The resultant green cotton/polyaniline composite was washed repeatedly with de-ionized water, 1 M HCl and finally with acetone. The composite was then dried at 50° C. under vacuum for two hours. The resistance of the cotton/polyaniline composite was 100 Ω/sq.

About 100 mg of the prepared cotton/polyaniline fibers was placed in 10 ml of 2.0 M silver nitrate solution/1 M nitric acid for a period of one week. The resultant cotton/polyaniline/silver composite was washed with de-ionized water, followed by rinsing with 0.5 M nitric acid. The composite was then dried at room temperature for 24 hours. The resistance of the composite was 20,000 Ω/sq.

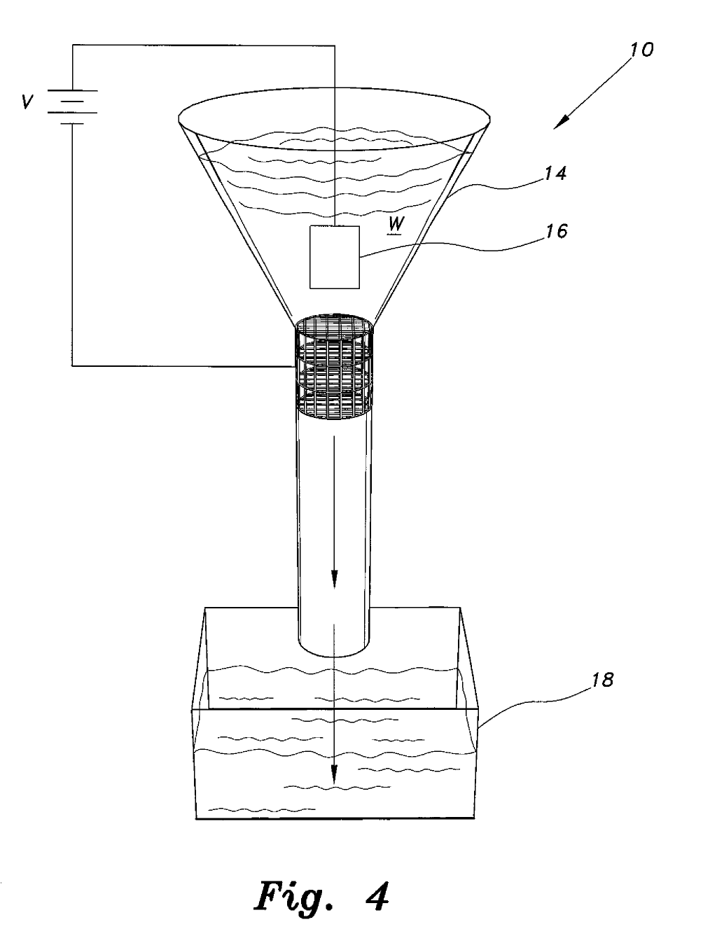

In use, as shown in FIG. 4, the matrix membrane 12, as prepared by any of the above methods, is used an electrode, which is positioned within a conduit, such as within exemplary funnel 14. A second conventional electrode 16 is also positioned within the funnel 14, such that potential source V generates an electrical path through the water W between electrodes 12, 16, and within the membrane electrode 12. Water passes through the membrane 12 and is collected in container 18. The polyaniline, silver and electrical current all contribute to antimicrobial activity in the matrix membrane.

In experiments, 80 mg of the matrix membrane was used as one electrode 12, and placed in a plastic funnel with a 5 mm diameter (in the lower, thinner portion of the funnel) and with a length of 3 cm. Contaminated water samples containing a nominal E. Coli bacterial density of 107-108 CFU/ml, were passed through the membrane filter with an adjusted rate of 15 ml/min. In each experimental run, a 100 ml water sample was allowed to flow through the device 10, and the treated solution was diluted 1,000 times, from which 100 μl was plated. The device 10 was operated with an applied voltage of 20 V. The bacterial inactivation efficiency was found to be 92% after the first run, and no E. Coli colonies were observed in the second run.

Overall, the sheet resistance of the matrix membrane prepared by any of the above methods is between 1 and 10⁶ Ω/sq. The silver content varies between 5% and 85% by weight of total composition. The system 10 may be used for the removal of common bacterial contamination of water, such as E. Coli, S. aureus, P. vulgaris and P. aeruginosa. The applied voltage is preferably up to ±100 V. The flow speed of the water passing through the matrix membrane filter 12 may be between 10 and 10,000 ml/min., and the water may be passed therethrough any suitable number of times, with two or three runs being preferred.

It is to be understood that the present invention is not limited to the embodiments described above, but encompasses any and all embodiments within the scope of the following claims.

We claim:

1. A method of making a water-sterilizing polymeric membrane, comprising the steps of:
coating cotton fiber with polyaniline doped with an acid to form a first composite material;
coating the first composite material with silver nanostructures to form a second composite material; and
forming the second composite material into a matrix membrane.

2. The method of making a water-sterilizing polymeric membrane as recited in claim 1, wherein the step of coating the cotton fiber with the polyaniline doped with the acid comprises coating the cotton fiber with the polyaniline doped with an acid selected from the group consisting of hydrochloric acid, nitric acid, formic acid, phosphoric acid, sulfuric acid, acetic acid, methanesulfonic acid, trifluromethanesulfonic acid, p-toluenesulfonic acid, naphthalene sulfonic acid, dinonylnaphthalenesulfonic acid, camphorsulfonic acid, polystyrenesulfonic acid, dodecylbenzenesulfonic acid, and combinations thereof.

3. The method of making a water-sterilizing polymeric membrane as recited in claim 1, wherein the step of coating the composite material with the silver nano structures comprises dip coating the composite material with the silver nanostructures.

4. The method of making a water-sterilizing polymeric membrane as recited in claim 3, wherein the step of coating the composite material with the silver nanostructures comprises coating the composite material with silver nanostructures selected from the group consisting of silver nanoparticles, silver nanowires, silver flakes, and combinations thereof.

5. The method of making a water-sterilizing polymeric membrane as recited in claim 1, wherein the step of coating the composite material with the silver nanostructures comprises conformal coating the composite material with the silver nanostructures.

6. The method of making a water-sterilizing polymeric membrane as recited in claim 5, wherein the step of coating the composite material with the silver nanostructures comprises coating the composite material with silver nano structures selected from the group consisting of silver nanoparticles, silver nanowires, silver flakes, and combinations thereof

7. The method of making a water-sterilizing polymeric membrane as recited in claim 1, further comprising the step of utilizing silver nitrate as an oxidizing agent for aniline monomer to form the polyaniline.

8. The method of making a water-sterilizing polymeric membrane as recited in claim 7, wherein the step of utilizing the silver nitrate as an oxidizing agent for the aniline monomer is performed in an acidic medium.

9. The method of making a water-sterilizing polymeric membrane as recited in claim 11, wherein the acidic medium comprises an acid selected from the group consisting of nitric acid and formic acid.

10. The method of making a water-sterilizing polymeric membrane as recited in claim 9, further comprising the step of adding an auxiliary reducing agent.

11. The method of making a water-sterilizing polymeric membrane as recited in claim 10, wherein the step of adding the auxiliary reducing agent comprises adding at least one auxiliary reducing agent selected from the group consisting of dimethyl formamide, formic acid, citric acid, ascorbic acid, formaldehyde, hydrogen peroxide, and sucrose.

12. The method of making a water-sterilizing polymeric membrane as recited in claim 11, further comprising the step of de-doping the polyaniline doped with the acid by addition of a base.

13. The method of making a water-sterilizing polymeric membrane as recited in claim 12, wherein the step of de-doping the polyaniline doped with the acid comprises de-doping the polyaniline with ammonium hydroxide.

14. The method of making a water-sterilizing polymeric membrane as recited in claim 13, further comprising the step of re-doping the polyaniline with an acid selected from the group consisting of hydrochloric acid, nitric acid, formic acid, phosphoric acid, sulfuric acid, acetic acid, methanesulfonic acid, trifluromethanesulfonic acid, p-toluenesulfonic acid, naphthalene sulfonic acid, dinonylnaphthalenesulfonic acid, camphorsulfonic acid, polystyrenesulfonic acid, dodecylbenzenesulfonic acid, and combinations thereof.

15. The method of making a water-sterilizing polymeric membrane as recited in claim 7, further comprising the step of utilizing a secondary oxidizing agent.

16. The method of making a water-sterilizing polymeric membrane as recited in claim 15, wherein the step of utilizing the secondary oxidizing agent comprises utilizing at least one secondary oxidizing agent selected from the group consisting of ammonium peroxydisulfate, ferric chloride, benzoic acid peroxide, and hydrogen peroxide.

17. A method of sterilizing water, comprising the steps of:
passing an electrical current through a matrix membrane formed from a composite of cotton fiber, polyaniline and silver; and
passing water to be sterilized through the electrified matrix membrane.

18. A filter electrode for sterilizing water comprising a membrane made from a composite of cotton, polyaniline, and silver.
